(19) United States
(12) Patent Application Publication
(10) Pub. No.: US 2022/0391999 A1
(43) Pub. Date: Dec. 8, 2022

(54) SYSTEM AND METHOD FOR DETERMINING AN AGRICULTURAL CULTIVATION STRATEGY

(71) Applicant: 365FarmNet Group KGaA mbH & Co. KG, Harsewinkel (DE)

(72) Inventor: Maximilian von Löbbecke, Berlin (DE)

(73) Assignee: 365FarmNet Group KGaA mbH & Co. KG, Harsewinkel (DE)

(21) Appl. No.: 17/834,134

(22) Filed: Jun. 7, 2022

(30) Foreign Application Priority Data
Jun. 8, 2021 (DE) 102021114697.6

(51) Int. Cl. G06Q 50/02; G06Q 10/10

(52) U.S. Cl. CPC G06Q 50/02; G06Q 10/1097

(57) ABSTRACT

A method and an agricultural management system for determining an optimized agricultural cultivation strategy is disclosed. The method includes: determining input factors by one or both of querying or evaluating information that influences one or both of the agricultural cultivation strategy or the crop rotation plan to be determined and information from or transmitted to external data sources independent of the agricultural management system; determining one or more optimization goals; selecting at least one of the specified optimization goals using an input/output unit; optimizing one or both of the agricultural cultivation strategy or crop rotation plan for the at least one selected optimization goal; and outputting the one or both of the optimized cultivation strategy or the optimized crop rotation plan using the input/output unit.

### CROSS REFERENCE TO RELATED APPLICATIONS

This application claims priority under 35 U.S.C. § 119 to German Patent Application No. DE 102021114697.6 filed Jun. 8, 2021, the entire disclosure of which is hereby incorporated by reference herein.

### TECHNICAL FIELD

The invention relates to a system (such as a computer-assisted agricultural management system) and method for determining an agricultural cultivation strategy (such as an optimized agricultural cultivation strategy).

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Crop rotation is an important component of agriculture and modern agricultural management, both in conventional and organic farming. Crop rotation gives farmers a certain amount of flexibility in marketing their products, protects the soil structure, prevents erosion for example, and saves costs for pesticides and fertilizer. In this regard, crop rotation is frequently considered an important element on the path to sustainable, soil-friendly agriculture.

The disadvantages of crop rotation are generally economical. Accordingly, crop rotation places particular demands on agricultural management. For example, different machines and techniques are needed for storing potatoes and sugar beets than grain. Today, not all farms have livestock, which means that the cycle of livestock farming and crop production envisaged at the time may only be realized to a limited extent. Intentionally fertilizing with animal fertilizers (e.g., liquid manure, slurry, stable manure) is frequently more difficult than using synthetic mineral fertilizers. The use of feed plants is therefore not always ensured. Intercropping may initially lead to additional costs, but over the long term, fertilizers may be saved by improving soil health.

Another consideration is climate change and the associated influence on agriculture. In addition to the reduction of greenhouse gases caused by agricultural processes, it may be beneficial to adapt to climate-related changes, such as the lengthening of growth periods.

US 2002/0103688 A1 discloses a method for determining an optimized agricultural cultivation strategy, and a computer-assisted agricultural management system. The method is based on an operator selecting a cultivation strategy in a first step and, in another step, boundary conditions are queried such as the use of resources using if-then queries. As a result, the method produces the anticipated operating costs of the selected cultivation strategy.

### BRIEF DESCRIPTION OF THE DRAWINGS

The present application is further described in the detailed description which follows, in reference to the noted drawings by way of non-limiting examples of exemplary implementation, in which like reference numerals represent similar parts throughout the several views of the drawings, and wherein:

FIG. 1 schematically shows an overview of an agricultural farm to be managed by an agricultural management system;

FIG. 2 schematically shows an abstracted representation of the agricultural management system;

FIG. 3 schematically shows a basic sequence for creating a cultivation strategy or crop rotation plan according to the prior art; and

FIG. 4 schematically shows an example of a sequence for creating an optimized cultivation strategy and/or an optimized crop rotation plan.

### DETAILED DESCRIPTION

As discussed in the background, various factors in selecting the cultivation strategy, including economic factors and climate-change factors, may be considered. These sometimes divergent factors may make it difficult for a farmer to determine basic cultivation strategies between two cultivation cycles toward a goal (such as an optimization goal), or to change them completely.

Further, in US 2002/0103688 A1, the operator must personally determine his/her optimum strategy in that the operator works with specifications for various boundary conditions and then compares the arising results with each other. This procedure may be very time-consuming and imprecise.

Against this backdrop, a system (such as a computer-assisted agricultural management system) and method are disclosed for determining an agricultural cultivation strategy (such as an optimized agricultural cultivation strategy) that assists a farmer to create and implement entire cultivation strategies.

Thus, in one or some embodiments, a method is disclosed for determining an agricultural cultivation strategy (such as an optimized agricultural cultivation strategy) by a computer-assisted agricultural management system which is characterized by any one, any combination, or all of the following steps:

determining one or more input factors by performing one or both of querying or evaluating information that influences or affects the cultivation strategy to be determined and is saved in the agricultural management system and information from or transmitted to external data sources independent of the agricultural management system;

determining (and optionally specifying), by the agricultural management system evaluating the one or more input factors, one or more optimization goals;

selecting, using an input unit (such as a farmer inputting the selection via an input/output unit) at least one of the specified optimization goals using;

determining (such as optimizing) one or both of the cultivation strategy or crop rotation plan for the at least one selected optimization goal including the determined input factors and resource planning and management (e.g., optimizing based on the one or more input factors and the at least one optimization goal); and

outputting, via an output unit (such as via the input/output unit), the one or both of the cultivation strategy or the crop rotation plan (e.g., the optimized cultivation strategy and/or the optimized crop rotation plan).

Thus, in one or some embodiments, a farmer is enabled to adapt or completely change basic cultivation strategies between two cultivation cycles in a calculated manner towards at least one optimization goal with less effort. The method may guide and assist the farmer in performing the process of determining an agricultural cultivation strategy (such as an optimized agricultural cultivation strategy). Various information resources may be used in the process. By way of example, available information resources, such as an existing farm management system maintained by the farmer or another operator that is for resource planning and management, may be used for this. The different input factors may form the basic conditions that influence, affect and/or limit the optimized cultivation strategy and/or optimized crop rotation plan to be determined. In one or some embodiments, a crop rotation plan may comprise a schedule of the types of crops cultivated in an agricultural area over vegetation period(s) and/or year(s). The cultivation strategy may determine the cultivation method and which measures may be pursued, for example the form of tillage, such as tilling corn fields with a plow or alternatively without a plow, increasing the crop yield by using more pesticides, the choice of the variety and/or the seeding rate of a crop on a specific field, or determining the time of sowing.

In particular, the agricultural management system may determine and provide one or more output factors that may describe any one, any combination, or all of the coordinated type, the location, the amount and the time of resources to be used for the optimized cultivation strategy and/or optimized crop rotation plan. In one or some embodiments, “resources to be used” means all of the necessary measures and resources to achieve an agricultural yield, whether by plant cultivation and/or livestock husbandry.

In particular, the agricultural management system (e.g., a farm management system) may retrieve the input factor(s) from at least one database as an internal data source, and determine by using geo-information and/or environmental information retrievable from the external data sources on a specific cultivation area that are detected by sensors, cultivation preferences, long-term weather forecasts and/or a selectable risk tolerance factor (interchangeable termed the selectable risk readiness factor). Retrieving input factors from the at least one database of the agricultural management system has the advantage that information incorporated in the agricultural management system by the farmer in the past is just as available as, for example, process data automatically transmitted by work machines and/or attachments to the agricultural management system. In addition, external data sources may be accessed that may be generally available through the Internet as a communication link. The external data sources may include the agricultural work machines and/or attachments which are employed by the farmer. These may be equipped with apparatuses for data collection, data recording and/or data transmission that determine or detect job-specific environmental, harvested material and/or machine parameters for the particular agricultural work machine and/or the particular attachment. In one or some embodiments, the apparatuses of the agricultural work machines and/or attachments may also have a suitable evaluation device that evaluates and processes the job-specific environmental, harvested material and/or machine parameters before they are transmitted to the agricultural management system. The evaluation of the environmental, harvested material and/or machine parameters may also be performed downstream from the agricultural work machine and/or the attachment by a data processing device set up for such evaluation. The data processing device may transmit the information to the agricultural management system in order to save it in the at least one database of the agricultural management system. In particular, the data processing device may be designed as the agricultural management system. The geoinformation and/or environmental information retrievable from the internal and external data sources on a specific cultivation area may be relevant to the crop rotation plan in order to be able to determine which crop sequence best corresponds to the at least one optimization goal on which field.

In one or some embodiments, at least one optimization goal may be selected from a plurality of optimization goals, such as from the group of any one, any combination, or all of: yield maximization; resource-saving processing; environmental compatibility; money-saving processing; least effort; profit optimization; or top-selling crop rotation. For example, the optimization goal of least effort may be more finely subdivided and, as the variable to be optimized, may concern the work time expended by the farmer himself/herself and/or the use of outside labor, for example. Likewise, this may include the use management of agricultural work machines. The optimization goal of environmental impact may, for example, concern exclusive organic cultivation of the harvested material, and/or emission-neutral cultivation practices. In particular, a plurality of optimization goals may be selected that are based on optimizing the cultivation strategy or the crop rotation plan. For example, the optimization goal of optimizing profit may be oriented around minimizing costs and/or selecting a particularly profitable cultivation strategy and/or crop rotation plan.

According to one development, when several optimization goals are selected, weighting may be performed that is adjustable by a changeable weighting parameter. Accordingly, an individual mixing strategy may be specified whose feasibility may be evaluated by the input factors. When performing the optimization to create an optimized cultivation strategy and/or an optimized crop rotation plan, discrepancies may be pointed out (e.g., highlighted to the farmer) that may result from contradictory optimization goals and/or may occur due to the weighting that is used. In one or some embodiments, the agricultural management system may output suitable instructions and/or display measures that may at least partly reduce these discrepancies identified by the agricultural management system.

In one or some embodiments, the one or more input factors may be updated (e.g., continuously updated) and adapted (e.g., responsive to receiving one or more updated values for the one or more input factors). In one or some embodiments, the frequency of or trigger for updating and adapting of at least one input factor may depend on the type of the particular input factor. In particular, a cycle that is specified by cultures cultivated on several fields and/or a crop sequence provided on a field may be used in order to specify intervals for updating (such as periodically updated) and adapting the at least one input factor.

In this case, the at least one input factor may be updated by transmitting and evaluating work data detected by sensors using the apparatus for data acquisition of at least one work machine and/or attachment communicating with the agricultural management system during or after an agricultural work process is performed. The work data may include any one, any combination, or all of environmental, harvested material, and/or machine parameters that may be detected by the agricultural work machine while performing an agricultural work process. Warehouses, silos and/or other work and usable areas on a farmyard of a farm may also be assigned equipment for data acquisition, or may be arranged thereupon.

In particular, a detailed schedule for performing the optimized cultivation strategy and/or the optimized crop rotation plan may be created and output by the agricultural management system. In so doing, the particular schedule may be retrievably saved in the agricultural management system.

Moreover, the determined schedule may be created for at least one period specific to harvested material. In one or some embodiments, a period specific to harvested material may be a single season for special harvested material. Alternatively or in addition, a period specific to harvested material may also be a multi-year plan.

Moreover, the specific schedule may be updated (such as continuously updated) by the agricultural management system. This may be done using documentation (e.g., documentation sent periodically or continuously) in the agricultural management system, and/or using information responsive to querying external data sources (e.g., regular or periodic querying of the external data sources). In this way, the optimization process and/or the optimization strategy may be updated (such as continuously updated) and, if necessary, one or more proposals adapted to changed basic conditions may be provided. By using such proposals, the farmer may decide to continue the selected cultivation strategy unchanged or adapted according to a proposal. Accordingly in the current harvest year, for example, an additional pesticide strategy may be proposed as an adaptation to the selected cultivation strategy that the farmer may choose. A change of variety within the crop rotation plan is also contemplated as an adaptation to the selected cultivation strategy.

In one or some embodiments, depending on the weighting, the input factors may be autonomously determined by the agricultural management system that require continuous updating (e.g., for which continuous updating is needed). The timing of the determined schedule may also influence the updating. For example, in a multi-year plan, business influences such as price trends, contracts for operating resources, specific contractual agreements with buyers of harvested material, or amended legal regulations may be given greater priority as input factors when evaluating the need for updating than is the case with short-term planning over just one cultivation season.

According to one embodiment, several different standard cultivation strategies or standard crop rotation plans may be saved in the agricultural management system that are used as a basis for optimizing a cultivation strategy and/or crop rotation plan. The standard cultivation strategies or standard crop rotation plans may accordingly be used like a template that the farmer may choose as a starting point. When the method is being performed, these templates may be adapted or rejected by determining the input factors.

According to one or some embodiments, a computer-assisted agricultural management system for use in the disclosed method is claimed. Reference is made to all statements or steps in the disclosed methodology, with the agricultural management system performing any one, some, or all of the steps in the disclosed methodology.

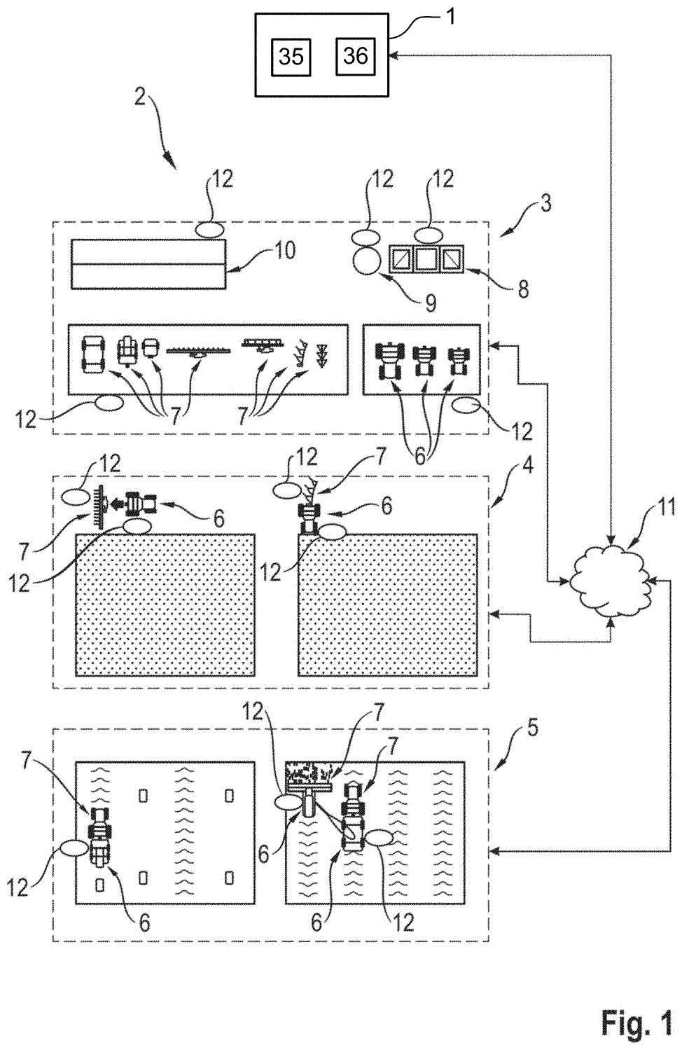

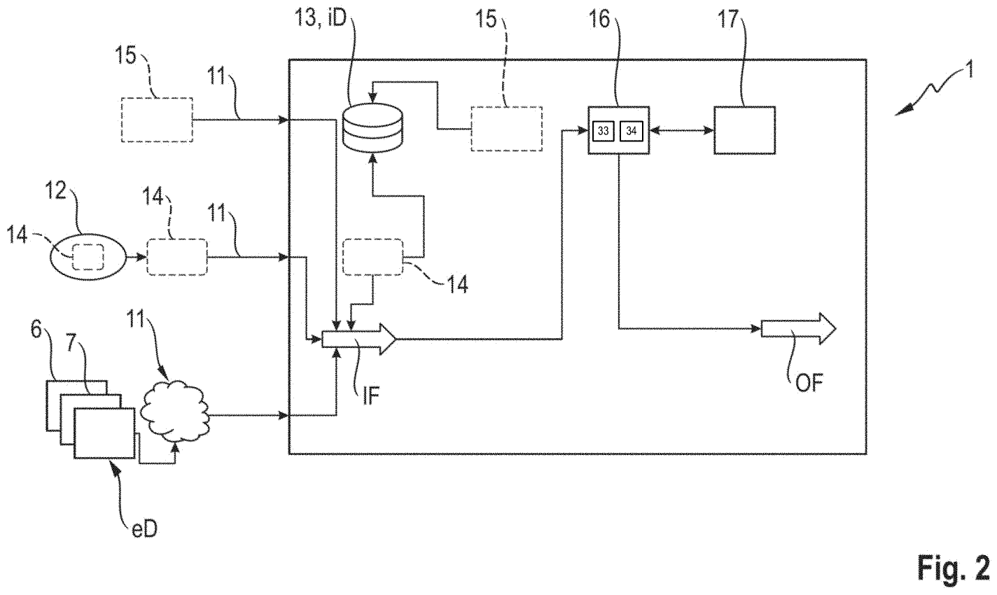

Referring to the figures, the depiction in FIG. 1 schematically shows an overview of an agricultural farm 2 to be managed by an agricultural management system 1, which may include computing functionality 35 (discussed further below) and a communication interface 36 (configured to communicate with one or more external computing devices). FIG. 2 schematically shows an abstracted representation of the agricultural management system 1.

In one or some embodiments, the term “farming” may be understood broadly and includes, among other things, the farmyard 3, one or more fields 4, 5 to be worked, agricultural work machines 6 and attachments 7. Moreover, various warehouses 8, silos 9 and other working and useful areas 10 such as workshops and/or for example stalls when livestock are used may be included in the farmyard 3. Agricultural work machines 6 include, for example, all harvesting machines needed for operating or used in the agricultural farm 2 such as any one, any combination, or all of: combines; forage harvesters; potato or beat harvesters or the like; towing vehicles such as tractors; or loading vehicles such as telescopic loaders. The term attachments 7 may include any one, any combination, or all of the following example attachments for the agricultural work machines 6: transport or loading wagons pulled by the work machine 6; pulled harvesters such as a baler; soil processing equipment; hay rakes; tedders; mowers; sprayers; or manure spreaders. The above lists are not to be understood as conclusive.

The agricultural management system 1 may communicate via communication interface 36 and may be connected by a communication link 11 to different apparatuses 12 for data acquisition, data detection and/or data transmission that are assigned to the agricultural work machines 6 and the attachments 7, the warehouses 8, silos 9 and/or the other work or useful areas 10 on the farmyard 3, or are arranged thereupon. The apparatuses 12 may be configured to transmit information to the agricultural management system 1 that is saved in at least one database 13 of the agricultural management system 1 as input factors IF. The information transmitted by the apparatuses 12 may be, among other things, a component of resource planning and resource management that may be performed by the agricultural management system 1. Thus, in one or some embodiments, the at least one database 13 may form an internal data source iD. The communication link 11 may include wireless and/or wired communication media.

The apparatuses 12 for data acquisition that are assigned to the agricultural work machines 6 and the attachments 7 or are arranged thereupon, form external data sources eD for the agricultural management system 1. The apparatuses 12 for data acquisition may be configured to determine or detect job-specific environmental, harvested material and/or machine parameters by sensors for the particular agricultural work machine 6 and/or the particular attachment 7. Work processes of the agricultural work machines 6 and attachments 7 for preparing and performing a particular agricultural work process may be detected or determined by the apparatuses 12. To accomplish this, environmental, harvested material and/or machine parameters may be detected by sensors by the particular apparatus 12 and evaluated by an evaluation device 14. In one or some embodiments, the evaluation device 14 may be part of the apparatus 12 of the work machine 6 and/or the attachment 7. In addition or alternatively, the evaluation device 14 may be designed as a data processing device of the work machine 6 and/or the attachment 7. It is also contemplated for the evaluation device 14 to be part of the agricultural management system 1, through which a downstream, such as a later, evaluation is performed.

In one or some embodiments, the particular apparatus 12 is configured to detect or determine the job-specific environmental, harvested material and/or machine parameters for the particular agricultural work machine 6 and/or the particular attachment 7 that may, inter alia, represent one or more input factors IF of the disclosed method.

In one or some embodiments, machine parameters detected by the apparatuses 12 comprise for example any one, any combination, or all of: operating data such as the use of operating fluids; yield data; position data; time data; etc. Harvested material parameters may comprise specific data on the harvested material during a processing procedure. Environmental parameters may comprise weather data during a processing procedure. Alternatively, or in addition, environmental parameters may be geo-information determined using the position data that may be provided by external data sources. Combined, the job-specific environmental, harvested material and/or machine parameters may allow (e.g., continuously allow) and coherent documentation of the use of the work machine 6 and/or the attachment 7 and the associated work results over a defined evaluation period. In one or some embodiments, the defined evaluation period may be a multi-hour or multi-day usage, a multi-month cultivation period up to a multi-year period.

Using the apparatuses 12 assigned to the warehouses 8, silos 9 and/or the other work and useful areas 10 in the farmyard 3 or arranged thereupon, additional parameters may be detected or determined as input factors IF that may influence or affect resource planning and/or resource management. This may include, for example, warehouse stock in the warehouses 8 or supplies in the silo 9 that may be detected and monitored by the apparatuses 12, such as by one or more sensors. Given the general proximity of warehouses 8, silos 9 and/or other work and useful areas 10 to the farmyard 3 and the unrestricted accessibility by at least the farmer, they may be considered internal data sources iD.

Moreover, in one or some embodiments, the agricultural management system 1 is connected to at least one input/output device 15 by the communication link 11. The at least one input/output device 15 may be arranged on a work machine 6. The at least one input/output device 15 may be a component of a mobile data processing device such as a cell phone, a tablet, etc. In one embodiment, the at least one input/output device 15 comprises an integrated input and output device (e.g., a touchscreen smartphone). Alternatively, the at least one input/output device 15 comprises an input device separate from an output device. In addition or alternatively, the agricultural management system 1 may comprise at least one input/output device 15. Using the at least one input/output device 15, information may be queried and/or entered that serves for documentation in a dialog with a farmer or another operator. The type of information is specified below. The agricultural management system 1 comprises at least one computing unit 16 as well as at least one memory unit 17 in which algorithms are saved that may be run by the computing unit 16 to process data. The computing unit 16 may comprise any type of computing functionality 35, such as at least one processor 33 (which may comprise a microprocessor, controller, PLA, or the like) and at least one memory 34. The memory 34 may comprise any type of storage device (e.g., any type of memory). Though the processor 33 and memory 34 are depicted as separate elements, they may be part of a single machine, which includes a microprocessor (or other type of controller) and a memory. Alternatively, computing unit 16 may rely on memory unit 17 for all of its memory needs.

The processor 33 and memory 34 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples. As discussed in detail below, computing unit 16, using software (e.g., computer executable instructions for executing the analytical routine) and/or hardware, is configured to perform the functions described herein.

In one or some embodiments, the results of processing the data (e.g., an optimized cultivation strategy and/or crop rotation plan), may be transmitted as output OF to the particular input/output device 15 and displayed to the farmer.

In addition to inputting via the at least one input/output device 15, other external data sources eD may be accessed that may be generally accessible through the Internet as a communication link 11. In this manner, any one, any combination, or all of current weather data, long-term weather forecasts, geo-information and/or environmental information on a specific cultivation area may be retrieved. The external data sources eD may moreover comprise, for example, information on any one, any combination, or all of legal regulations, purchase prices for example of operating fluids and seed, or sales prices of harvested material, and may also form input factor(s).

Additional input factor(s) may be formed by any one, any combination, or all of: the information generated by querying and/or evaluating the cultivation strategy to be determined and/or crop rotation planning to be influenced (which may be retrievably stored in the at least one database 13 of the agricultural management system 1); information from external data sources eD independent of the agricultural management system 1; or information transmitted to the agricultural management system 1.

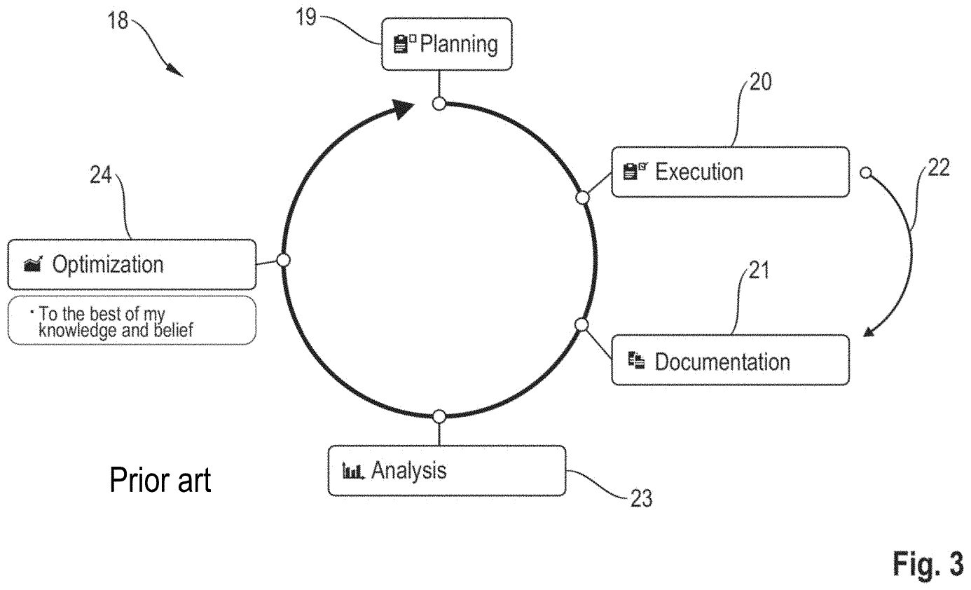

FIG. 3 schematically shows a basic sequence for creating a cultivation strategy or crop rotation plan according to the prior art. The sequence is executed as a continuous planning cycle 18 that starts with one planning step 19 for at least one type of crop to be cultivated. This is followed by at least one execution step 20 that comprises the performance of different steps to be performed in a certain sequence that are necessary for preparing, cultivating and harvesting the type of crop. This is followed by at least one documentation step 21 associated with the at least one execution step 20. The at least one documentation step 21 may be performed as at least one partially automated process step 22. An analysis step 23 of the execution step 20 uses the particular documentation step 21. The analysis step 23 forms the basis of an optimization step 24 in which the farmer independently decides the point of the initially specified crop rotation plan at which changes may be necessary to achieve an improvement in, for example, the yield or the use of resources that are reflected in the following planning step 19. Farmers are under pressure to succeed financially and, usually left to their own devices, are rarely in a position to make calculated adjustments to basic cultivation strategies between two cultivation cycles toward an optimization goal, or to change them completely.

In particular, there is an abundance of information to be processed, which is present even when there are only a small number of fields 4, 5 to be processed, resources to be used, etc., and which may also change during a cultivation cycle, for example due to external influences, presents the farmer with major hurdles.

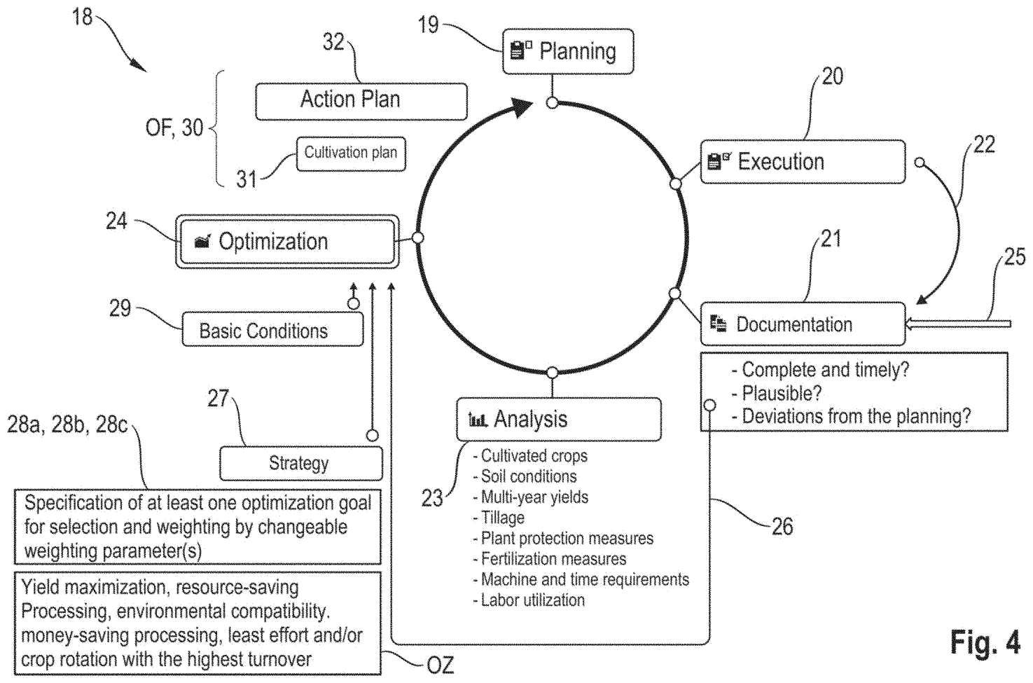

FIG. 4 shows a schematic example of a process according to one embodiment for creating an optimized cultivation strategy and/or an optimized crop rotation plan that is based on the above-described planning cycle 18.

While performing the at least one documentation step 21 after performing at least one execution step 20 (e.g., after at least partly performing or entirely performing the at least one execution step), it may be checked during the execution of the method according to one embodiment of the invention whether the documentation not included by the partially automated process step 22 (e.g., the particular documentation to be carried out in a manual process step 25 by the farmer or the operator) has been performed completely and in a timely manner. While executing the at least one documentation step 21, plausibility checks may be provided or performed in order to check the accuracy of the documentation performed in the manual process step 25. This may allow, for example, incorrect assignments of input factors IF to be determined and displayed while executing a documentation step 21 or after a documentation step 21. For example, input factors IF provided by the agricultural work machines 6 and/or the attachments 7, which may be entered in the manual process step 25, may be erroneously assigned to field 5, even though the agricultural work machines 6 and/or the attachments 7 were being used on the field 4 according to a resource plan in the previous planning step 19.

Performing the documentation step 21 also comprises checking the input factors IF with respect to their completeness, timeliness and plausibility that are detected by the partially automated process step 22.

Moreover, the documentation step 21 checks whether planning deviations 26 have occurred from the plan established in the previous planning step 19. The result of this evaluation, (e.g., an identified plan deviation 26) may be considered in performing the optimization step 24 that may be executed at a later time.

In one or some embodiments, the analysis step 23 follows the documentation step 21. In the analysis step 23, input factors IF may be evaluated that were entered, received or otherwise transmitted and compiled in the documentation step 21. In the analysis step 23, various input factors IF may be used including any one, any combination, or all of: cultivated crops; crop rotations; existing soil conditions; yield overviews of the different fields 4, 5; performed tillage measures; performed crop protection measures; performed fertilization measures; actual resource use such as machine and time requirements as well as labor utilization. In one or some embodiments, the various input factors IF may be used in the subsequent optimization step 24.

In one or some embodiments, the following optimization step 24 may comprise several substeps, determining a strategy 27, and basic (or general) conditions 29 to be executed by the agricultural management system 1 to determine a schedule 30, considering the evaluation of the input factors IF in order to generate (and output) an optimized cultivation strategy and/or crop rotation plan as output OF. In one or some embodiments, the schedule 30 comprises a cultivation plan 31 and a complete action plan 32.

In the strategy 27 substep, any one, any combination, or all of specification 28a, selection 28b or weighting 28c of at least one optimization goal OZ are performed as method steps. In one or some embodiments, one or more from the following group are shown to the farmer in the specification 28a method step by the input/output device 15: yield maximization; resource-saving processing; environmental compatibility; money-saving processing; least effort; profit optimization; or top-selling crop rotation. Responsive to showing the one or more optimization goals OZ to the farmer, the farmer may select at least one in the selection 28b method step. In one or some embodiments, the strategy 27 substep and associated method steps of specification 28a, selection 28b and weighting 28c are performed in a dialog (e.g., via the input/output device 15).

In one or some embodiments, the optimization goal OZ of “least effort” may be more finely subdivided and, as the variable to be optimized, may concern the work time expended by the farmer himself/herself and/or the use of outside labor, for example. Likewise, the use management of agricultural work machines may belong to the optimization goal OZ of “least effort”. Another optimization goal OZ may be “environmental compatibility”, wherein the optimization goal SIZE may for example be based on purely organic cultivation of the harvested material, and/or emission-neutral cultivation practices. In particular, in one or some embodiments, a plurality of optimization goals OZ may be selected that serve as the basis for optimizing the cultivation strategy or the crop rotation plan. The selection of one or more optimization goals OZ may comprise another input factor IF that may be incorporated in the optimization process in the optimization step 24.

Thus, in one or some embodiments, one or more specified optimization goals OZ is selected in the selection 28b method step via the input/output device 15.

When a plurality of optimization goals OZ are selected, in the weighting 28c method step, weighting of the different optimization goals OZ may be performed that may be adjustable by a changeable weighting parameter. In weighting, the influence or effect of the particular optimization goal OZ on the optimized cultivation strategy and/or crop rotation plan is specified that the plan should have based on input from the farmer. Accordingly, an individual mixing strategy may be specified whose feasibility may be evaluated by the other input factors IF in the optimization step 24. In one or some embodiments, discrepancies may be shown or displayed to the farmer when performing the optimization to create an optimized cultivation strategy and/or an optimized crop rotation plan that result from contradictory optimization goals OZ and/or may occur due to the weighting that is used. In a particular embodiment, in addition to the identified discrepancies being output, suitable instructions may be output and/or measures may be displayed to the farmer that may at least reduce these identified discrepancies.

In the basic conditions 29 substep, influences are ascertained or determined as input factors IF that may be externally determined. Merely by way of example, business influences that may be included as input factors may comprise any one, any combination, or all of: price trends; contracts for operating resources; specific contractual agreements with buyers of harvested material; availability of agricultural work machines 6 and/or attachments 7 from third parties such as contractors; or amended legal regulations. Alternatively, or in addition, other input factors IF ascertained or determined in the basic conditions 29 substep may, for example, be any one, any combination, or all of: the climate as a long-term input factor IF; the weather as a short-term input factor IF; resource offers; feed requirements; or cultures that are geographically suitable and/or recommended for cultivation. Other input factors IF to be determined in the basic condition 29 substep may be risk tolerance and/or existing cultivation preferences of the farmer. In one or some embodiments, the basic conditions 29 (e.g., boundary conditions) sub step may be performed (such as at least partially performed) in a dialog.

Consequently, a schedule 30 comprising a cultivation plan 31 and a complete action plan 32 may be determined and provided by the agricultural management system 1 as output factors OF (which may be output to the farmer) for the optimized cultivation strategy determined for the method, and/or the optimized crop rotation plan, with the output factors OF that, coordinated with each other, may describe any one, any combination, or all of the type, location, quantity, and/or timing of resources to be used.

In one or some embodiments, the output schedule 30 may serve to implement the optimized cultivation strategy determined using the available input factors IF, and/or the optimized crop rotation plan after executing the optimization step 24. By the method according to one aspect of the invention, the farmer is provided with the optimized cultivation strategy and/or the optimized crop rotation plan that may come closer (e.g., closest) to his specifications made in the strategy 27 sub step. One, some or all of the steps for determining the optimized cultivation strategy and/or the optimized crop rotation plan for determining, evaluating and comparing input factors IF are depicted herein. In contrast to the aforementioned prior art, a comparison is therefore unnecessary of different ascertained cultivation strategies that are based on the boundary condition specifications to be made by the farmer in the sense of input factors.

In one or some embodiments, the cultivation plan 31 and the complete action plan 32 may form the basis of the planning step 19 that again follows for implementing the optimized cultivation strategy and/or the optimized crop rotation plan. Within this continuous planning cycle 18, one or more fixed points may be used. For example, the selection of a culture, the availability of farm resources such as available labor, and/or the agricultural work machines 6 and attachments 7 may form basic fixed points. In one or some embodiments, these fixed points that may be simultaneously input factors IF and may be changed by a corresponding intervention, which in turn may lead to an adaptation or a changing of the optimized cultivation strategy and/or the optimized crop rotation plan determined in a previous cycle.

In one or some embodiments, the planning cycle 18 includes continuous (e.g., at predetermined times or triggered based on one or more acts, such as based on data input) updating and adaptation of at least one input factor. The frequency of updating and adapting at least one input factor depends on the type of the particular input factor IF. A cycle that is specified by cultures cultivated on several fields and/or a crop sequence provided on a field may be used in order to specify intervals for continuously updating and adapting at least one input factor. Continuous adaptation of part of the input factors IF may result from the at least partially automated documentation in process step 22, and the execution of a manual process step 25 during the documentation step 21.

In one or some embodiments, input factors IF ascertained or determined in the basic conditions 29 substep may at least be partially updated by automatic queries (e.g., responsive to the automatic queries, receiving one or more updated values for the one or more input factors). Specific input factors IF may be influenced or affected by decisions of the farmer, such as for example contractual obligations to meet cultivation standards and/or husbandry standards that are determined in the basic conditions 29 substep, and may contrastingly need manual updating when switching from one standard to another standard (e.g., switching from conventional cultivation to organic cultivation). The requirements associated with a changed standard may also be at least partially retrieved from external data sources eD for updating. Accordingly, these are available to the optimization step 24 to be correspondingly considered when performing the disclosed methodology.

According to another feature, the input factors IF may be autonomously determined depending on the weighting of selected optimization strategies OZ, which may necessitate continuous updating performed in the weighting 28c substep.

In one or some embodiments, several different standard cultivation strategies or standard crop rotation plans may be saved in the agricultural management system 1, which may then be used as a basis for first creating or subsequently adapting an optimized cultivation strategy and/or crop rotation plan. The standard cultivation strategies or standard crop rotation plans may accordingly be used like a template that the farmer may choose as a starting point. When the method is being performed, these templates may be adapted or rejected by continuously determining and updating the input factors IF.

The determined schedule 30 may be saved in the memory unit 17 of the agricultural management system 1. A cloud-based system is also contemplated, at least for saving the schedule 30. In principle, it is however also contemplated to provide the computing unit 16 and/or the memory unit 17 in an external data processing system outside of the farmyard 3, for example in an external computer network (e.g., a cloud computing environment). In the latter case, the algorithm may be used, and/or said data may be saved in particular in the cloud. In particular, the agricultural management system 1 may be cloud-based.

In one or some embodiments, the determined schedule 30 may be created for at least one harvested material-specific period. A period specific to harvested material may be a single season for special harvested material. A period specific to harvested material may also be a multi-year plan. Within these harvested material-specific periods, adaptations may be made that are based on updated input factors IF, and/or interim changes in the context of determining the strategy 27, and/or basic conditions 29 (e.g., boundary conditions). The method according to the invention offers great flexibility with respect to adapting to changed conditions. Moreover, the method according to the invention takes into account all of the influences relevant in this context in order to output an optimized cultivation strategy and/or the optimized crop sequence plan, or adapt them with optimized parameters.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Agricultural management system

2 Agricultural farm

3 Farmyard

4 Field

5 Field

6 Work machine

7 Attachment

8 Warehouse

9 Silo

10 Work and useful area

11 Communication link

12 Apparatus for data acquisition

13 Database

14 Evaluation device

15 Input/output device

16 Computing unit

17 Memory unit

18 Planning cycle

19 Planning step

20 Execution step

21 Documentation step

22 Process step

23 Analysis step

24 Optimization step

25 Manual process step

26 Plan deviation

27 Strategy sub step

28a Specification method step

28b Selection method step

28c Weighting method step

33 Processor

34 Memory

35 Computing functionality

36 Communication interface

IF Input factor

OF Output factor

OZ Optimization goal

eD External data source

iD Internal data source

29 Basic conditions substep

30 Schedule

31 Cultivation plan

32 Action plan

1. A method for determining an agricultural cultivation strategy by a computer-assisted agricultural management system, the method comprising:
determining one or more input factors by querying or evaluating one or both of information that affects one or both of the agricultural cultivation strategy or a crop rotation plan to be determined or information from or transmitted to external data sources independent of the agricultural management system;
determining, by the agricultural management system evaluating the one or more input factors, one or more optimization goals;
selecting, via at least one input unit, at least one optimization goal from one or more optimization goals;
determining, based on the one or more input factors and the at least one optimization goal, the at least one optimization goal and resource planning and management, one or both of the agricultural cultivation strategy or crop rotation plan; and
outputting the one or both of the agricultural cultivation strategy or the crop rotation plan using at least one output unit.

2. The method of claim 1, wherein outputting the one or both of the agricultural cultivation strategy or the crop rotation plan comprises outputting one or more output factors for the one or both of the agricultural cultivation strategy or optimized crop rotation plan, the one or more output factors indicating a coordinated type, a location, an amount and a time of resources to be used.

3. The method of claim 1, wherein the one or more input factors are retrieved from at least one database as an internal data source of the agricultural management system; and
wherein the one or more input factors are determined by using one or both of geo-information or environmental information retrievable from the external data sources on a specific cultivation area that are detected by one or more of sensors, cultivation preferences, long-term weather forecasts or a selectable risk tolerance factor.

4. The method of claim 1, wherein the one or more optimization goals comprise yield maximization, resource-saving processing, environmental compatibility, money-saving processing, least effort, profit optimization, or top-selling crop rotation.

5. The method of claim 4, wherein selecting at least one optimization goal comprises selecting a plurality of optimization goals; and
further comprising performing adjustable weighting of the plurality of optimization goals based on a changeable weighting parameter.

6. The method of claim 5, wherein the agricultural management system autonomously determines the one or more input factors based on the changeable weighting parameter.

7. The method of claim 1, further comprising cyclically updating and adapting at least one input factor.

8. The method of claim 7, wherein the at least one input factor is updated by transmitting and evaluating work data detected by sensors using an apparatus for data acquisition of one or both of an agricultural work machine or at least one attachment communicating with the agricultural management system during or after an agricultural work process is performed.

9. The method of claim 1, further comprising creating, by the agricultural management system, and outputting a schedule for performing optimized cultivation strategy and optimized crop rotation plan.

10. The method of claim 9, wherein the schedule is retrievably saved in the agricultural management system.

11. The method of claim 9, wherein the schedule is created for at least one harvested material-specific period.

12. The method of claim 9, further comprising autonomously updating, by the agricultural management system, the schedule responsive to updated values for the one or more input factors.

13. The method of claim 1, further comprising accessing a plurality of cultivation strategies or a plurality of crop rotation plans that are saved in the agricultural management system; and
wherein optimizing the one or both of the agricultural cultivation strategy or the crop rotation plan based on the plurality of cultivation strategies or the plurality of crop rotation plans.

14. A computer-assisted agricultural management system comprising:
a communication interface configured to receive one or both of information that affects one or both of an agricultural cultivation strategy or a crop rotation plan to be determined or information from or transmitted to external data sources independent of the agricultural management system;
an input/output device; and
computing functionality configured to:
determine one or more input factors by querying or evaluating one or both of the information that affects one or both of the agricultural cultivation strategy or the crop rotation plan to be determined or the information from or transmitted to external data sources independent of the agricultural management system;
determine, by evaluating the one or more input factors, one or more optimization goals;
select, via the input/output device, at least one optimization goal from one or more optimization goals;
determine, based on the one or more input factors and the at least one optimization goal, the at least one optimization goal and resource planning and management, one or both of the agricultural cultivation strategy or crop rotation plan; and
output, via the input/output device, the one or both of the agricultural cultivation strategy or the crop rotation plan.

15. The agricultural management system of claim 14, wherein the computing functionality is configured to output the one or both of the agricultural cultivation strategy or the crop rotation plan by outputting one or more output factors for the one or both of the agricultural cultivation strategy or optimized crop rotation plan, the one or more output factors indicating a coordinated type, a location, an amount and a time of resources to be used.

16. The agricultural management system of claim 14, further comprising at least one database;
wherein the computing functionality is further configured to retrieve the one or more input factors from the at least one database as an internal data source of the agricultural management system; and
wherein the computing functionality is configured to determine the one or more input factors by using one or both of geo-information or environmental information retrievable from the external data sources on a specific cultivation area that are detected by one or more of sensors, cultivation preferences, long-term weather forecasts or a selectable risk tolerance factor.

17. The agricultural management system of claim 14, wherein the one or more optimization goals comprise yield maximization, resource-saving processing, environmental compatibility, money-saving processing, least effort, profit optimization, or top-selling crop rotation.

18. The agricultural management system of claim 17, wherein the computing functionality is configured to select the at least one optimization goal by selecting a plurality of optimization goals; and
wherein the computing functionality is further configured to perform adjustable weighting of the plurality of optimization goals based on a changeable weighting parameter.

19. The agricultural management system of claim 18, wherein the computing functionality is configured to autonomously determine the one or more input factors based on the changeable weighting parameter.

20. The agricultural management system of claim 14, wherein the computing functionality is further configured to:
create a schedule for performing optimized cultivation strategy and optimized crop rotation plan; and
output, via the input/output device, the schedule.
